(19) United States
(12) Patent Application Publication
(10) Pub. No.: US 2019/0251581 A1
(43) Pub. Date: Aug. 15, 2019

(54) SYSTEM AND METHOD FOR CLIENT APPLICATION USER ACQUISITION

(71) Applicant: Cognant LLC, Mountain View, CA (US)

(72) Inventors: Jared Maruskin, San Jose, CA (US); Jerome Turnbull, Mountain View, CA (US); Heng Wang, San Jose, CA (US); Kent Shi, Sunnyvale, CA (US); Arun Kejariwal, Fremont, CA (US); Yi Sin Chiu, San Mateo, CA (US); Erin Hassey, San Francisco, CA (US)

(21) Appl. No.: 16/263,762

(22) Filed: Jan. 31, 2019

Related U.S. Application Data
(60) Provisional application No. 62/630,425, filed on Feb. 14, 2018.

(51) Int. Cl. G06Q 30/02; A63F 13/79

(52) U.S. Cl. CPC G06Q 30/0204; A63F 13/79; G06Q 30/0277; G06Q 30/0201

(57) ABSTRACT

A method, a system, and an article are provided for acquiring new users of a client application. An example method includes: providing the client application to a group of users; obtaining data related to interactions between the client application and each user; providing the data to a predictive model configured to receive the data as input and provide as output a predicted value for each user; identifying a subset of users for whom the predicted value exceeds a predetermined threshold; for each user in the subset of users, providing an identification of the user to a new user finder; and providing the client application to a new group of users, wherein the new group of users was acquired through the new user finder based on the provided identification of the subset of users.

### CROSS-REFERENCE TO RELATED APPLICATIONS

This application claims the benefit of U.S. Provisional Patent Application No. 62/630,425, filed Feb. 14, 2018, the entire contents of which are incorporated by reference herein.

### BACKGROUND

The present disclosure relates to software applications and, in particular, to systems and methods for identifying and acquiring new users of software applications, such as a software application for a multiplayer online game.

In general, a multiplayer online game can be played by hundreds of thousands or even millions of players who use client devices to interact with a virtual environment for the online game. The players are typically working to accomplish tasks, acquire assets, or achieve a certain score in the online game. Some games require or encourage players to form groups or teams that can play against other players or groups of players. Players can gain a competitive advantage over other players by acquiring skills or assets that other players may not have. Such skills or assets can be acquired in some instances through user activity, transactions, and/or purchases in the multiplayer online game.

### SUMMARY

In general, the subject matter of this disclosure relates to systems and methods for identifying and acquiring new users of a client application, for example, for a multiplayer online game. Data for existing users of the client application is used to develop a model that predicts a value for each of the existing users. The value can be or include, for example, a prediction of how valuable each user will be to the client application, such as a degree to which the user is expected to engage with the client application. A subset of high-value users is identified within the existing group of users, and an identification of each high-value user (e.g., in the form of a device ID) is provided to a new user finder. The new user finder processes the user identifications to acquire new prospective users of the client application. In preferred examples, the new user finder utilizes a separate model configured to find new prospective users who are similar to the existing high-value users. The client application can be provided to the prospective users who choose to download and install the client application.

Advantageously, the systems and methods described herein represent an improvement in the way that new users of a client application can be identified and acquired. For example, the systems and methods provide control over the frequency at which user information is provided (referred to herein as a “post-back”) to the new user finder. In a typical implementation, the new user finder may expect to receive information each time a user achieves a particular event (e.g., completes a user tutorial or reaches a level of achievement) in the client application and/or may expect such events to occur at a certain rate, such that post-backs are received at a certain frequency. For some client applications, however, the occurrence of such events may be inconsistent with the new user finder's expected post-back frequency. Advantageously, however, the systems and methods described herein are able to control the frequency at which post-backs are provided to the new user finder. Additionally or alternatively, the systems and methods can send post-backs according to a true value of each user, rather than according to the occurrence of specific events in the client application. The resulting post-back information enables the new user finder to identify and acquire new users who have a greater likelihood of being valuable to the client application.

In one aspect, the subject matter described in this specification relates to a method (e.g., a computer-implemented method). The method includes: providing a client application to a group of users; obtaining data related to interactions between the client application and each user in the group of users; providing the data to a predictive model configured to receive the data as input and provide as output a predicted value of each user in the group of users, the predicted value including a predicted measure of how valuable the user will be to the client application; identifying a subset of users in the group of users for whom the predicted value exceeds a predetermined threshold; for each user in the subset of users, providing an identification of the user to a new user finder; and providing the client application to a new group of users, wherein the new group of users was acquired through the new user finder based on the provided identification of the subset of users.

In certain examples, the client application is or includes an online game. The data can describe or relate to user characteristics, client device characteristics, and/or a history of user activity. The predicted value for each user in the group of users can include a predicted likelihood that the user will be a payer in the client application. The predicted value for each user in the group of users can include a predicted level of engagement with the client application. The identification can include the predicted value and/or a respective client device identifier.

In various implementations, the new user finder can be configured to identify prospective new users for the client application based on the provided identification of the subset of users. The new user finder can be further configured to provide the prospective new users with offers to install the client application. The method can include adjusting the predetermined threshold to achieve a desired frequency at which the identifications are provided to the new user finder. The method can include: identifying a second subset of users in the group of users for whom the predicted value does not exceed the predetermined threshold; and providing an identification to the new user finder of one or more users in the second subset of users based on random number generation.

In another aspect, the subject matter described in this specification relates to a system having one or more computer processors programmed to perform operations including: providing a client application to a group of users; obtaining data related to interactions between the client application and each user in the group of users; providing the data to a predictive model configured to receive the data as input and provide as output a predicted value of each user in the group of users, the predicted value including a predicted measure of how valuable the user will be to the client application; identifying a subset of users in the group of users for whom the predicted value exceeds a predetermined threshold; for each user in the subset of users, providing an identification of the user to a new user finder; and providing the client application to a new group of users, wherein the new group of users was acquired through the new user finder based on the provided identification of the subset of users.

In certain examples, the client application is or includes an online game. The data can describe or relate to user characteristics, client device characteristics, and/or a history of user activity. The predicted value for each user in the group of users can include a predicted likelihood that the user will be a payer in the client application. The predicted value for each user in the group of users can include a predicted level of engagement with the client application. The identification can include the predicted value and/or a respective client device identifier.

In various implementations, the new user finder can be configured to identify prospective new users for the client application based on the provided identification of the subset of users. The new user finder can be further configured to provide the prospective new users with offers to install the client application. The operations can include adjusting the predetermined threshold to achieve a desired frequency at which the identifications are provided to the new user finder. The operations can include: identifying a second subset of users in the group of users for whom the predicted value does not exceed the predetermined threshold; and providing an identification to the new user finder of one or more users in the second subset of users based on random number generation.

In another aspect, the subject matter described in this specification relates to an article. The article includes a non-transitory computer-readable medium having instructions stored thereon that, when executed by one or more computer processors, cause the computer processors to perform operations including: providing a client application to a group of users; obtaining data related to interactions between the client application and each user in the group of users; providing the data to a predictive model configured to receive the data as input and provide as output a predicted value of each user in the group of users, the predicted value including a predicted measure of how valuable the user will be to the client application; identifying a subset of users in the group of users for whom the predicted value exceeds a predetermined threshold; for each user in the subset of users, providing an identification of the user to a new user finder; and providing the client application to a new group of users, wherein the new group of users was acquired through the new user finder based on the provided identification of the subset of users.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for identifying and acquiring new users of a client application.

FIG. 2 is a schematic diagram of a method of identifying and acquiring new users of a client application.

FIG. 3 is a schematic diagram of a new user finder module configured to identify and acquire new users of a client application.

FIG. 4 is a flowchart of an example method of identifying and acquiring new users of a client application.

### DETAILED DESCRIPTION

In various implementations, the systems and methods described herein utilize a predictive model (e.g., a machine learning model) to predict a value for a user of a client application (or other product or service). The model can make the predictions based on one or more user characteristics (e.g., demographics, client device data, user geographical location, etc.) and/or user behavior, such as user activity from before and/or after installation of the client application. In various implementations, the predicted value for a user can be or include, for example, a predicted level or likelihood of user engagement with the client application and/or with other users of the client application, a predicted probability that the user will be a payer (e.g., will make purchases or other payments) in the client application, and/or a predicted amount of revenue that the user will generate in or for the client application. Other indications of user value are possible.

Based on the predicted values for a group of users, a probabilistic approach can be used to determine whether or not information on each user will be provided (e.g., as a “post-back”) to a new user finder component or entity. In general, the higher the value (e.g., higher payer probability) for a user, the more likely it is that the user will trigger a post-back. For example, users having predicted values that meet or exceed a threshold value may always trigger a post-back, while users having predicted values less than the threshold value may or may not trigger a post-back. In some instances, random numbers are generated to determine whether post-backs are sent for users whose values are less than the threshold value. This approach, in general, results in the new user finder receiving post-back information (e.g., a device ID and a predicted value) for users who have the highest values.

In preferred implementations, the new user finder can use the post-back information to develop or train an additional model (e.g., a “user finder model”) to look for and acquire new, high-value users for the client application. For example, the new user finder can identify prospective users who have characteristics in common with existing, high-value users of the client application (e.g., users with high payer probabilities). The new user finder can then send communications to the prospective users that encourage the prospective users to download and install the client application. When a prospective user installs the client application and becomes a new user, the systems and methods described herein can monitor the new user's interactions with the client application, predict a value for the new user, and determine whether a post-back should be sent for the new user. Thus, the process of predicting user values to identify and acquire new, high-value users can be ongoing.

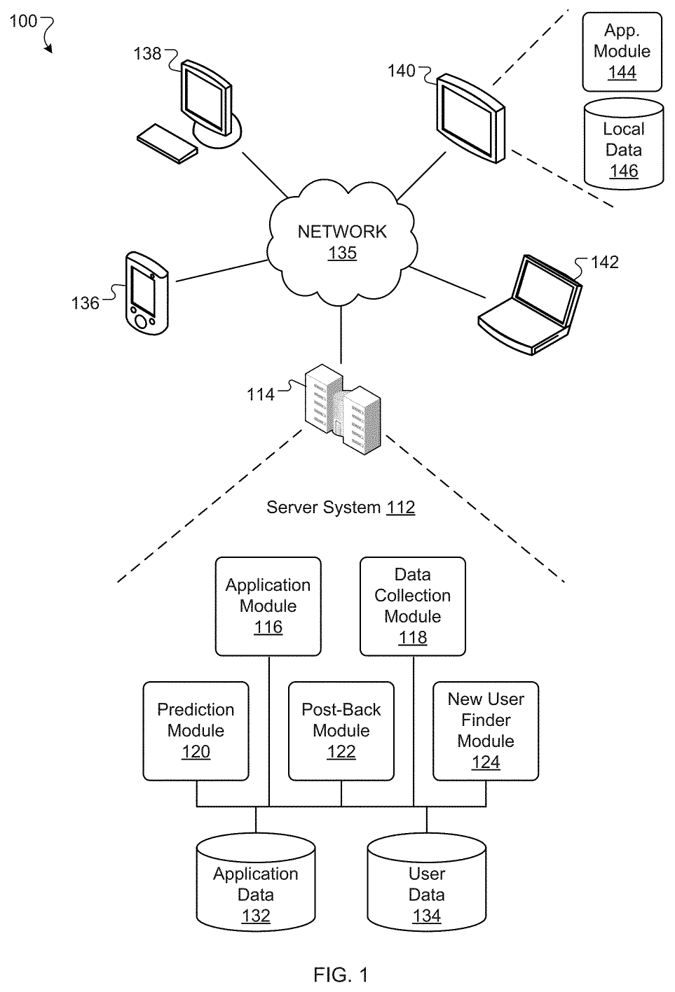

FIG. 1 illustrates an example system 100 for identifying and acquiring new users of a client application. A server system 112 provides functionality for processing data related to user interactions with the client application. The server system 112 includes software components and databases that can be deployed at one or more data centers 114 in one or more geographic locations, for example. In certain instances, the server system 112 is, includes, or utilizes a content delivery network (CDN). The server system 112 software components can include an application module 116, a data collection module 118, a prediction module 120, a post-back module 122, and a new user finder module 124 (alternatively described herein as the “new user finder”). The software components can include subcomponents that can execute on the same or on different individual data processing apparatus. The server system 112 databases can include an application data 132 database and a user data 134 database. The databases can reside in one or more physical storage systems. The software components and data will be further described below.

The client application, such as, for example, a client-based and/or web-based software application, can be provided as an end-user application to allow users to interact with the server system 112. The client application can relate to and/or provide a wide variety of functions and information, including, for example, entertainment (e.g., a game, music, videos, etc.), business (e.g., word processing, accounting, spreadsheets, etc.), news, weather, finance, sports, etc. In preferred implementations, the client application provides a computer game, such as a multiplayer online game. The client application or components thereof can be accessed through a network 135 (e.g., the Internet) by users of client devices, such as a smart phone 136, a personal computer 138, a tablet computer 140, and a laptop computer 142. Other client devices are possible. In alternative examples, the application data 132 database, the user data 134 database, or any portions thereof can be stored on one or more client devices. Additionally or alternatively, software components for the system 100 (e.g., the application module 116, the data collection module 118, the prediction module 120, the post-back module 122, and/or the new user finder module 124) or any portions thereof can reside on or be used to perform operations on one or more client devices.

Additionally or alternatively, each client device in the system 100 can utilize or include software components and databases for the client application. The software components on the client devices can include an application module 144, which can implement or provide the client application on each client device (e.g., the application module 144 can be the client application or portions thereof). The databases on the client devices can include a local data 146 database, which can store data for the client application and exchange the data with the application module 144 and/or with other software components for the system 100, such as the data collection module 118. The data stored on the local data 146 database can include, for example, user history data, user transaction data, image data, video data, audio data, and/or any other data used or generated by the system 100. While the application module 144 and the local data 146 database are depicted as being associated with the tablet computer 140, it is understood that other client devices (e.g., the smart phone 136, the personal computer 138, and/or the laptop computer 142) can include the application module 144, the local data 146 database, or any portions thereof.

FIG. 1 depicts the application module 116, the data collection module 118, the prediction module 120, the post-back module 122, and the new user finder module 124 as being able to communicate with the application data 132 database and the user data 134 database. The application data 132 database generally includes application data used to implement the client application on the system 100. The application data can include, for example, image data, video data, audio data, application parameters, initialization data, and/or any other data used to run the client application. The user data 134 database generally includes data related to the users of the client application. Such data can include, for example, user characteristics (e.g., geographical location, gender, age, and/or other demographic information), client device characteristics (e.g., device model, device type, platform, and/or operating system), and/or a history of user activity that occurred prior to, during, or after installation of the client application on the client devices. The history of user activity can include, for example, information related to content presentations on the client devices, user interactions with the content presentations, and publishers of the content presentations (e.g., websites and/or other applications). In general, the history can include information about how each user first installed and began using the client application. The history can be or include, for example, data summarizing each content presentation and any user interactions with the content presentations. Such data can include, for example, a device identifier, a publisher name and/or publisher identifier, a timestamp for a presentation time, a timestamp for a user interaction time, and/or similar data for each content presentation. Additionally or alternatively, the history of user activity can include user inputs to the client devices, user messages, user achievements or advancements (e.g., in an online game), user engagements with other users, user assets, user purchases, user sales, and/or similar activity. In the context of an online game, the history of user activity can include a record of any purchases made by players, for example, to acquire virtual items, additional lives, new game features, or some other advantage.

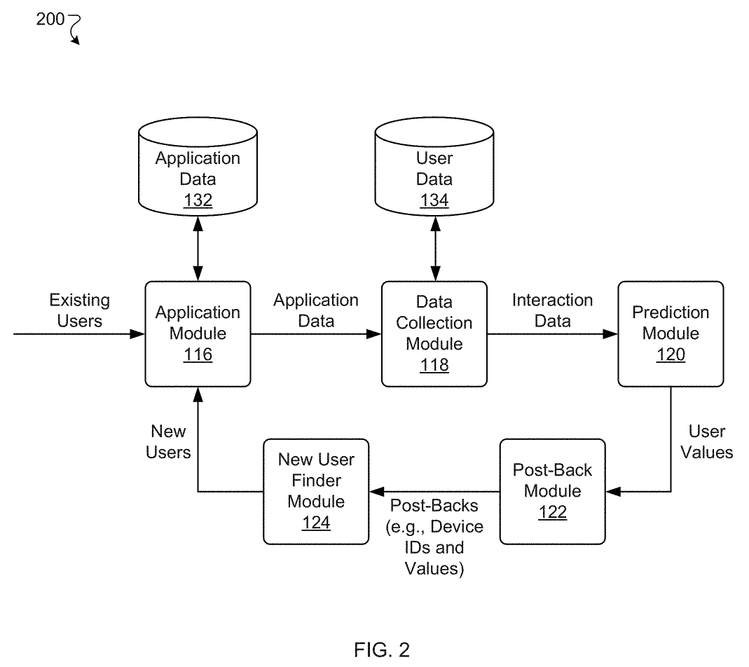

Referring to FIG. 2, in various examples, a method 200 can utilize the application module 116, the data collection module 118, the prediction module 120, the post-back module 122, and the new user finder module 124 to acquire new users of the client application. The application module 116 (and/or the application module 144) can utilize application data from the application data 132 database to provide the client application to an existing group of users. Data related to user activity from before and/or after installation of the client application can be collected by the data collection module 118, which can store data in and retrieve data from the user data 134 database. The user interaction data can be provided to the prediction module 120, which can use one or more predictive models (also referred to herein as “value prediction models”) to predict a value for each user in the existing group of users. The predicted value can be or include, for example, an indication of how valuable the user will be to the client application. For example, the predicted value for a user can be or include an indication of a likelihood that the user will be a payer (e.g., will make purchases or other payments) in the client application or when using the client application. Additionally or alternatively, the predicted value for a user can be or include a predicted level of user engagement and/or a predicted amount of revenue (e.g., in U.S. dollars) that the client application will derive from the user (e.g., during an initial time period or during a user lifetime). In preferred examples, user values can be predicted for users who recently began using the client application (e.g., within the previous hour, day, or week). In alternative examples, user values can be predicted for any users of the client application, regardless of when the users began using the client application.

Next, the predicted values are provided from the prediction module 120 to the post-back module 122, which can identify a subset of high-value users in the existing group of users. To achieve this, the post-back module 122 can identify users in the existing group of users who have a predicted value that exceeds a predetermined threshold. For example, if the predetermined threshold is 10, the post-back module 122 can identify all users in the existing group of users who have a predicted value greater than 10. Information for each user in the subset of high-value users can be provided (as a “post-back”) to the new user finder module 124. The information can include, for example, a timestamp (e.g., a time/date at which the information was provided), a client device identifier (e.g., a device ID), and/or the predicted value for the user.

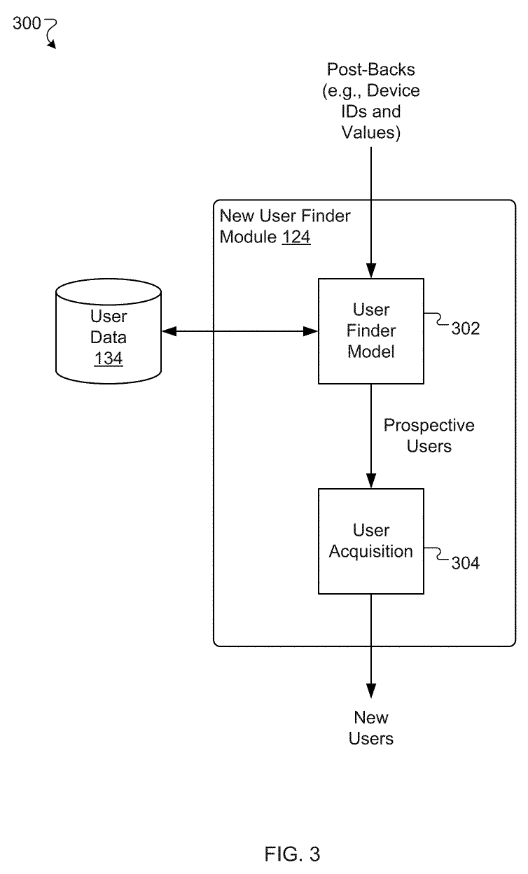

The new user finder module 124 can process the information received from the post-back module 122 to identify and acquire new users for the client application. Referring to FIG. 3, in an example method 300, the new user finder module 124 includes or utilizes a user finder model 302 that identifies prospective new users. The user finder model 302 can include one or more equations (e.g., regression equations) or other classifiers that are developed or trained using information received from the post-back module 122. For example, the new user finder module 124 can use post-back information such as device IDs and/or predicted user values as training data for the user finder model 302. Additionally or alternatively, the new user finder module 124 preferably has access (e.g., via the user data 134 database) to user information associated with each device ID. This can allow the user finder module 124 to associate each device ID with various user characteristics, including demographic information and user histories. Such user characteristics can be combined with the device IDs and/or predicted user values and used to train the user finder model 302. Once trained, the user finder model 302 can recognize prospective new users who are similar to existing, high-value users of the client application. In some instances, the user finder module 124 can access the user data 134 database (or other database) to obtain information for prospective users. The user finder model 302 can receive the information for the prospective users as input and provide as output an identification of prospective users who are predicted to be high-value.

Once a desired set of prospective users has been identified, the user finder module 124 can utilize a user acquisition component 304 to present the prospective users with items of content that describe the client application (or other product or service), for example, in the form of text, images, sounds, and/or video. The user acquisition component 304 can use or include one or more publishers to present the items of content, which can include, for example, one or more offers that promote the client application and/or encourage the prospective users to install the client application on their client devices. The prospective users can interact with the content and can be provided with opportunities to install the client application (e.g., for an online game) on their client devices. Prospective users who proceed to download and install the client application can become new users of the client application. Referring again to FIG. 2, the application module 116 can provide the client application to the new users, and the method 200 can be repeated to acquire additional new users.

In various examples, the new user finder module 124 can be or include a component and/or entity that uses one or more publishers (e.g., websites or software applications) to provide communications to prospective users in an effort to acquire new users of the client application. The new user finder module 124 can be, include, or utilize, for example, one or more advertising networks or mobile advertising networks, such as GOOGLE or FACEBOOK. In a typical implementation, the new user finder module 124 can require or expect the post-back module 122 to pass certain back-end data or information (referred to herein as “post-backs”) to the new user finder module 124. For example, the new user finder module 124 can expect to receive post-back information each time an existing user of the client application completes an in-app event. Such in-app events can be or include, for example, activating the client application, signing in to the client application, making a first purchase in the client application, completing a tutorial in the client application, using the client application for a certain amount of time (e.g., 10 minutes, one hour, or one day), logging in to the client application a certain number of times (e.g., 1 time or 10 times), or reaching a certain level of achievement in the client application (e.g., level 10 in an online game). These in-app events are typically deterministic and correspond directly to certain action taken by users in the client application. The new user finder module 124 can use the post-back information to train or refine the user finder model 302, which can identify users who are more likely to complete the in-app events.

This approach of sending post-back information only when specific in-app events are reached can be problematic, given that such events correspond directly to certain action taken by users in the client application (e.g., completing a tutorial or a level) and may not be correlated with a true value that a user brings to the client application. Low-quality or low-value users, for example, can be capable of achieving the same in-app actions as high-quality or high-value users. In one example, a low-value user on a 5-year old mobile phone may complete the same event (e.g., complete level 10 in an online game) as a high-value user on a brand new iPHONE. When the event triggers a post-back and the user finder model 302 is trained using the post-back information, the user finder model 302 may learn to recognize such users as being equally valuable, even though one of the users (e.g., the user with the new iPHONE) may be significantly more valuable to the client application. It is therefore preferable to train or develop the user finder model 302 using post-backs that more accurately reflect a true value of the users.

Another problem associated with sending post-backs based on in-app events is that there can be little control over the frequency at which post-backs are provided. For example, it may be typical for 50% of users of a first client application to reach an in-app event (e.g., tutorial completion) while only 5% of users of a second application reach the same in-app event. This can result in too many post-backs for the first client application and not enough post-backs for the second client application. Both scenarios can be less than ideal for training the user finder model 302 to recognize potential high-value users. For example, too many post-backs can result in a weak correlation between the post-back events and a true user value. On the other hand, not enough post-backs can result in insufficient training data for the user finder model 302. Additionally or alternatively, providers of client applications (or other products) can take into account multiple signals and evaluate user quality from multiple dimensions (such as age, gender, location, geographical location, device type, etc.), whereas the new user finder module 124 (e.g., ad networks) can be intrinsically set up with a framework of optimizing on only a single binary dimension (e.g., completion of an in-app event). Advantageously, the systems and methods described herein can overcome these problems by implementing and using a probabilistic approach to sending post-backs, preferably based on a predicted user value rather than on one or more deterministic events.

In certain implementations, for example, a new type of event (referred to herein as a “Hermean” event) can be triggered by the post-back module 122 and can appear and behave indistinguishably from deterministic events (based on in-app events) from the perspective of the new user finder module 124. To implement this approach, the prediction module 120 can be configured to receive user data (e.g., demographic data, client device data, and/or in-app engagement metrics) as input and provide predictions of user values as output (e.g., in the form of key performance indicators or KPIs). For example, a provider of the client application may wish to optimize for payer rate, such that user value depends on how likely the user is to be a payer in the client application. In this case, the value prediction model in the prediction module 120 can predict the payer probability of each user. Different key performance indicators can be used in other examples. For example, the value prediction model can be used to predict the probability that a user will reach a certain level in an online game, login a certain number of times, use the client application for a certain number of hours, and/or generate a certain amount of revenue for the client application. For purposes of illustration and not limitation, much of the discussion herein describes the value prediction model as being configured to predict payer probability. It is understood, however, that the value prediction model can be used to predict other KPIs or indications of user value. In preferred examples, the indications of user value are or include a probability that the user will do something of value, such as, for example, become a payer, generate a certain level of revenue, reach of certain level of engagement in the client application, and the like.

Given the output from the value prediction model, the post-back module 122 can implement and use a set of rules for sending post-backs based on the occurrence of Hermean events. In general, when a Hermean event is determined to occur for a user, a post-back can be triggered and sent for the user. In a typical example, the payer probability and/or post-back probability (alternatively referred to herein as Hermean event probability) can be calculated for a user when the user reaches a certain threshold amount of interaction with the client application (or other product or service). For example, the post-back probability can be calculated for each user after the user has been using the client application for one day, two days, one week, or other suitable time period.

Hermean events can be sub-typed into various classes. For example, Threshold Hermean Events (THE) are one type of Hermean event for which a post-back is triggered as long as the payer probability reaches a threshold value T This class of Hermean event may or may not be coupled with a deterministic event. For example, a post-back can be sent for a user when the payer probability is greater than 1% and the user reaches a specific in-app event.

Random Element Hermean Events (REHE) are another type of non-deterministic Hermean event. The post-back module 122 can use REHEs to send post-backs at a higher frequency for users with a higher probability of pay. For example, as with THE, a post-back can be sent for each user having a payer probability P that exceeds a threshold value T (e.g., 10% or other suitable value). For users having payer probabilities less than or equal to the threshold value T, however, the probability of sending a post-back can be given by:

$$PostBack Probability = \frac{P}{T} . \qquad ( 1 )$$

For example, when the threshold T is 10% and a particular user's payer probability P is 2%, the probability of sending a post-back can be 20%, given that 20%=2%/10%, from equation (1). In some instances, the post-back module 122 can generate a random number to determine whether a post-back is sent for this particular user. For example, the post-back module 122 can be configured to (i) send a post-back when the random number (drawn from a range of 0-100) is less than or equal to the post-back probability (20 in this example) and (ii) to not send a post-back when the random number is greater than the post-back probability.

Other classes of Hermean events include Random Differential Hermean Events (RDiff) and Threshold Differential Hermean Events (TDiff), which are similar to REHE and THE, respectively. With RDiff and TDiff, the predicted payer probability can be tracked and/or updated over time based on the development and acquisition of additional user data (e.g., in-app engagement data). The event signal can be computed as a difference between the current probability and a previous probability (e.g., a maximum value or high-water mark), so as to provide a differential outcome. In some instances, for example, RDiff and TDiff events can occur for users at any time after users begin using the client application. By contrast, REHE and THE events generally occur at a specific time after users begin using the client application.

In one example involving THE and TDiff, a post-back can be triggered when the payer probability for a user surpasses a threshold value T (or other value). For THE, the payer probability is computed at a certain epoch for each user of the client application (e.g., 24 hours after installation of the client application). For TDiff, the payer probability can be updated over time and a post-back can be sent if and when the payer probability ultimately exceeds the threshold value T For both THE and TDiff, the post-back probability for a user whose payer probability surpasses the minimum threshold T can be 100%, and the post-back probability for all other users can be 0%. Thus, an event can be triggered 100% of the time whenever a user's payer probability exceeds the minimum threshold.

Alternatively or additionally, in an example involving REHE and RDiff, a user-level payer prediction can be determined at a fixed epoch in the client application (e.g., for REHE) or can be updated as time progresses (e.g., for RDiff). Using the predicted payer probability, a post-back probability (Hermean event probability) can be formulated based on the threshold probability T, which can control a frequency at which post-backs are provided. When a user has a payer probability greater or equal to the threshold T, a post-back can be triggered 100% of the time. Alternatively, when the user's payer probability is less than the threshold T, the probability of sending a post-back can be proportional to the predicted payer probability. In preferred examples, the probability of sending an event post-back p(E) based on the payer probability P can be given by

p(E)=min(100%,P/T). (2)

With this approach, p(E) is equal to P/T when P/T is less than 100%; otherwise, p(E) is equal to 100%. As explained above, a random number can be generated to determine if a post-back is sent for user when p(E) is less than 100%. When the generated random number is less than or equal to p(E), for example, a post-back can be sent.

In general, the threshold T can be adjusted to obtain a desired number or frequency of post-backs. For example, the threshold T can be increased to decrease the post-back frequency, or the threshold T can be decreased to increase the post-back frequency. In some instances, for example, a frequency of post-backs can be monitored and the threshold T can be adjusted in an effort to reach a desired post-back frequency. Various control schemes, such as proportional control, integral control, and/or derivative control can be used to adjust the threshold T and control the post-back frequency.

Advantageously, the use of Hermean events, as described herein, can result in post-back events being sent probabilistically rather than deterministically. Further, with REHE and RDiff, a given user may or may not trigger a post-back event, depending on the random number drawn for the user. The Hermean event approach can allow the likelihood of sending a post-back event to mirror the likelihood that a user will become a payer or will achieve some other desired user KPI. In some examples, this can achieve bidding by frequency. Each post-back event can correspond to an equal expected value.

In certain implementations, a minimum payer probability (or other minimum KPI) can be required before a post-back is sent for a user. When the payer probability for a given user is below this minimum value, for example, p(E) can be set equal to zero such that no post-back event is sent for the user. Additionally or alternatively, when the payer probability satisfies the minimum value, p(E) can be determined using equation (2).

In various instances, Hermean events can be calibrated so that the event frequency (e.g., based on the probability of sending an event postback for a given user) mirrors a payer likelihood. This can have the benefit of normalizing the expected value per event. For example, Table 1 presents two examples (A and B) for the REHE class in which there are 100 users, the threshold value T is 10%, and the value per payer is $500 (e.g., each user who is a payer is estimated to spend a total of $500 in the client application). The payer probability for each user is 10% in example A and 3% in example B. The results in the table indicate that post-back probabilities p(E), as determined from equation (2), are 100% and 30% for examples A and B, respectively. Given the total number of users (100) and the payer probabilities (10% and 3%), the expected number of payers is 10 and 3 in examples A and B, respectively. Given this number of payers and the payer value of $500/payer, the expected total value for examples A and B is $5,000 and $1,500, respectively. Finally, given the post-back probabilities p(E), the expected value per post-back is $50 in both examples (e.g., $5,000/100 in example A and $1,500/30 in example B).

TABLE 1
REHE examples involving 100 users.

| Item | Example A | Example B |
|---|---|---|
| Input Parameters | | |
| Number of Users | 100 | 100 |
| Payer probability for Each User | 10% | 3% |
| Threshold Value | 10% | 10% |
| Expected Value Per Payer | $500 | $500 |
| Hermean Event Class | REHE | REHE |
| Output Parameters | | |
| Post-Back Probability p (E) | 100% | 30% |
| Expected Number of Post-Backs | 100 | 30 |
| Expected Number of Payers | 10 | 3 |
| Expected Total Value | $5,000 | $1,500 |
| Expected Value per Post-Back | $50 | $50 |

Still referring to FIG. 2, the data collection module 118 is generally configured to collect data that the system 100 uses to predict the values for users of the client application. The data collection module 118 can obtain data related to digital content presentations on client devices and any user interactions with the digital content. Additionally or alternatively, the data collection module 118 can obtain data related to user characteristics (e.g., geographical location, gender, age, and/or other demographic information), client device characteristics (e.g., device model, device type, platform, and/or operating system), and/or any user interactions or transactions with the client application. The data collection module 118 can provide the data to the user data 134 database and the prediction module 120. In various examples, the data collection module 118 can utilize or include an attribution service provider. The attribution service provider can receive data or information from publishers related to the presentation of content and user actions in response to the content. The attribution service provider can determine, based on the information received, how to attribute the user actions to individual publishers.

The data provided by the data collection module 118 to the prediction module 120 can be used to predict a value for each existing user of the client application. The predicted value for a user can be or include, for example, a predicted likelihood that the user will become a payer, a predicted level of engagement with the client application, and/or a predicted amount of revenue generated by the user. The prediction for each user is preferably made within a time period (e.g., one week, one month, or other time period) after the user first installed or began using the client application. For example, the prediction module 120 can predict a likelihood that a user will become a payer within one week or one month of first beginning to use the client application. Additionally or alternatively, the prediction module 120 can collect and monitor user data over longer time periods and/or can predict user values for such time periods. The prediction module 120 can, for example, predict a likelihood that a user will become a payer within six months, one year, or other longer time period after first installing or using the client application. In preferred implementations, the value prediction model in the prediction module 120 can be periodically or continually updated or retrained with new data, so that the value prediction model remains current and accurate. For example, the systems and methods can be run on a periodic basis (e.g., hourly, daily, or other suitable time period) using the most recent data for new users and the most recent model predictions.

In general, the prediction module 122 can include one or more value prediction models for predicting the value of existing users of the client application (or other product or service). The data from the data collection module 118 can be divided into subsets of data in which each subset can correspond to, for example, a distinct user age, where user age is or represents a length of time since a user first installed or began using the client application. For example, a user who installed or began using the client application yesterday can have a user age of one day. In preferred examples, data for users having a first user age (e.g., one day) can form a first subset of data, data for users having a second user age (e.g., two days) can form a second subset of data, and so on, to form a total of N subsets of data, where N can be any integer greater than one. For example, an Nth subset of data can include data for users having a user age of N days. In some instances, user age can be measured in hours, weeks, months, or other units of time.

Each subset of data can then be provided as input to one or more value prediction models, which can include, for example, (i) a payer model configured to predict the likelihood that a user will become a payer for the client application and (ii) and a revenue model configured to predict the amount of revenue that a user will generate for the client application. In preferred examples, each value prediction model is tailored to make predictions for a specific user age. For example, a first payer model and a first revenue model can be tailored to make predictions for users having a user age corresponding to the first subset of data (e.g., a user age of one day). Likewise, a second payer model and a second revenue model can be tailored to make predictions for users having a user age corresponding to the second subset of data (e.g., a user age of two days). As a user advances in age, data for the user can be assigned to a new subset of data, which can be processed by a new payer model and/or a new revenue model.

In various examples, each payer model can be configured to predict a probability that a user, who is not currently a payer, will become a payer by the time the user reaches a target user age (e.g., one week or one month). For example, the first payer model can be used to predict the probability that a user having a user age of one day will become a payer by the time the user reaches a user age of one week. When the user is not already a payer, the first payer model can make the prediction based on any available user data (e.g., in the user data 134 database) for the user. Likewise, the second model can be used to predict the probability that a user having a user age of two days will become a payer by the time the user reaches the user age of one week. Additional payer models can be used to predict payer probability as the user advances in age. In general, as more user data is collected for the user, the models can receive more information as input and can provide more accurate predictions. For example, a payer model that makes predictions based on 10 days of user data will generally be more accurate (e.g., based on root-mean-square error) than the first payer model, which can make predictions based on one day of user data.

In some instances, a user may become a payer by making a transaction in the client application. In that case, the payer probability for the user is already known (e.g., 100%), and there is generally no need to predict payer probability for that specific user. Each user can be assigned a value indicating whether the user is a payer (e.g., payer value=1) or a non-payer (e.g., payer value=0). Additionally or alternatively, the value prediction models can provide a probability that a user will become a payer (e.g., 10%, 20%, 50%, or 100%). As described herein, the value prediction models can be used to predict other KPIs for user value, in addition to or instead of payer probability or revenue.

In general, the value prediction models can be used to perform regression or classification and are preferably tree-based, though other suitable models can be used. Tree-based learning algorithms are generally robust to outliers. Tree-based methods can split a feature space into distinct and non-overlapping regions, and the splits can be performed based on information gain. The approach can require relatively little data preparation compared to other algorithms. In a preferred approach, gradient boosting trees can combine weak learners (e.g., decision trees) in an additive and iterative manner, with a model in each iteration correcting a predecessor model. The value prediction models can be based on or can utilize, for example, gradient boosting trees, neural networks, and/or random forest, though other regression models or classifiers can be used.

In various implementations, the user data provided to the value prediction models in the prediction module 120 can be or include a wide variety features describing user behavior or activity from before or after installation of the client application. Pre-installation user data can include, for example, install platform (e.g., iOS or ANDROID), device model (e.g., iPHONE 6), device country code, Internet Protocol (IP) country code, and the like. Such data can capture a user profile from before installation of the client application and can be weighed more heavily for new users and less heavily for older users. Post-installation user data can capture a user profile based on user interactions with the client application. For purposes of illustration and not limitation, when the client application is for a computer game, such as a multiplayer online game, the post-installation user data can include one or more game features including, but not limited to, total power (e.g., a measure of player influence over other players), user level, research complete (e.g., a measure of user skill level), and/or play minutes (e.g., a total time spent playing the game). As user age increases, the value prediction models can weigh the post-installation user data more heavily than the pre-installation user data. The post-installation user data can become, for example, the most indicative factor for determining a user's future engagement in the client application, as well as the user's propensity to become a payer and/or generate revenue. The value prediction models can be retrained based on any new user data received from the data collection module 118. This can allow the value prediction models to learn the influences of the various input data types and evolve over time.

While preferred implementations for the prediction module 120 can use separate value prediction models to predict separate KPIs (e.g., payer probability and revenue), some implementations can utilize a single model to make such predictions. For example, the prediction module 120 can utilize a single value prediction model to predict multiple KPIs for one or more user ages. In such an instance, for example, the single value prediction model can receive input data for all user ages and provide KPI predictions for each user and/or for groups of users.

The ability of the prediction module 120 to predict the value of one or more users of a client application can be important for several reasons. For example, in the mobile gaming context, users sharing similar in-game behavior might perform very differently in terms of revenue. Even the most engaged user can have less than a 30% chance of being a payer. Further, the amount of revenue generated by payers can vary significantly. In general, user value predictions can be more accurate when more user data is used to make the predictions. For example, users with 6 hours of engagement data can generate more accurate predictions than with users with 4 hours of engagement data.

In some instances, a small number of users can account for a large portion of the transactions or total revenue generated by the client application. To prevent the value prediction models from being skewed by such users and/or to avoid inaccurate model predictions, the user data and/or model predictions can be adjusted to indicate that such users have a lower payer probability or lower revenue predictions. For example, the payer probability and/or the total amount of revenue for each user can be capped at maximum values.

In various examples, the new user finder module 124 can be used to acquire new users of the client application. New users can be acquired, for example, by presenting digital content related to the client application on client devices of prospective users. In some instances, the digital content can be or include images, videos, audio, computer games, text, messages, offers, and any combination thereof. The digital content can encourage prospective users to download, install, and/or begin using the client application. The prospective users can interact with the digital content and be presented with opportunities to install and/or use the client application. In a typical example, the user new user finder module 124 can utilize one or more publishers (e.g., websites or other client applications) to present the digital content.

To extract actionable insights from big data, it can be important to leverage big data technologies so that processing of large volumes of data can be supported. Two key big data technologies that can be used for the systems and methods described herein include, but are not limited to, APACHE PIG and APACHE HBASE. APACHE PIG is, in general, a platform for analyzing large sets of data that takes advantage of high-level language to express data analysis programs and includes infrastructure for evaluating these programs. APACHE PIG can be used as part of the data collection module 118. APACHE HBASE is, in general, a column-oriented key/value data store built to run on top of the HADOOP Distributed File System (HDFS). APACHE HBASE can be used as part of the data collection module 118.

In various examples, the models developed and/or used by the systems and methods described herein can be or include one or more regression equations or classifiers such as, for example, one or more linear classifiers (e.g., Fisher's linear discriminant, logistic regression, Naive Bayes classifier, and/or perceptron), support vector machines (e.g., least squares support vector machines), quadratic classifiers, kernel estimation models (e.g., k-nearest neighbor), boosting (meta-algorithm) models, decision trees (e.g., random forests, Gradient Boosting Trees), neural networks, and/or learning vector quantization models. Other classifiers can be used.

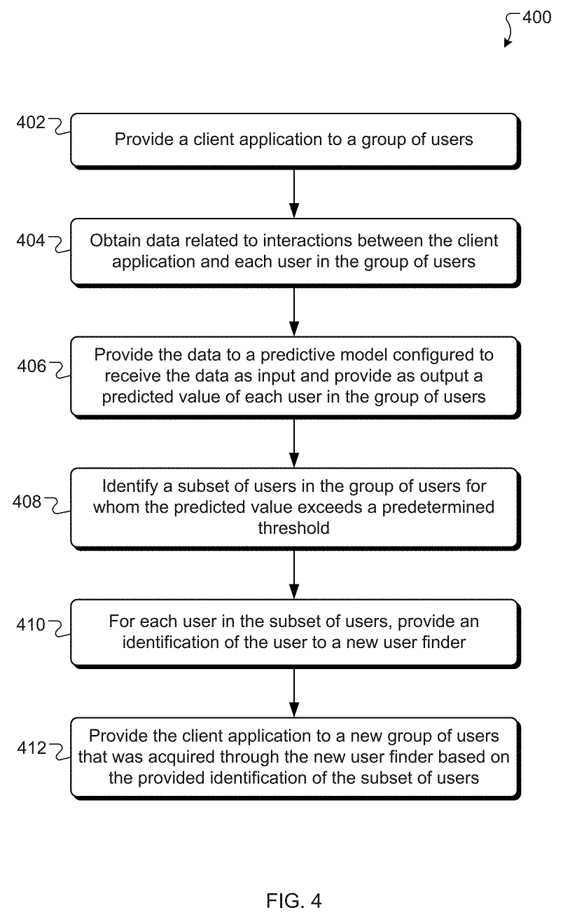

FIG. 4 illustrates an example computer-implemented method of acquiring new users of a client application. A client application is provided (step 402) to a group of users. Data is obtained (step 404) that relates to interactions between the client application and each user in the group of users. The data is provided (step 406) to a predictive model (also referred to herein as a “value prediction model”) configured to receive the data as input and provide as output a predicted value of each user in the group of users. The predicted value can be or include a predicted measure of how valuable the user will be to the client application. A subset of users in the group of users for whom the predicted value exceeds a predetermined threshold is identified (step 408). For each user in the subset of users, an identification of the user is provided (step 410) to a new user finder. The client application is provided (step 412) to a new group of users that was acquired through the new user finder based on the provided identification of the subset of users.

While much of the discussion herein relates to identifying and acquiring new users of a client application, it is understood that the systems and methods described herein are also generally applicable to a wide range of other products and services. For example, the systems and methods can be used to acquire new users of products and services related to healthcare, travel, leisure, entertainment, transportation, and the like.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, client application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method, comprising:
providing a client application to a group of users;
obtaining data related to interactions between the client application and each user in the group of users;
providing the data to a predictive model configured to receive the data as input and provide as output a predicted value of each user in the group of users, the predicted value comprising a predicted measure of how valuable the user will be to the client application;
identifying a subset of users in the group of users for whom the predicted value exceeds a predetermined threshold;
for each user in the subset of users, providing an identification of the user to a new user finder; and
providing the client application to a new group of users,
wherein the new group of users was acquired through the new user finder based on the provided identification of the subset of users.

2. The method of claim 1, wherein the client application comprises an online game.

3. The method of claim 1, wherein the data describes at least one of user characteristics, client device characteristics, or a history of user activity.

4. The method of claim 1, wherein the predicted value for each user in the group of users comprises a predicted likelihood that the user will be a payer in the client application.

5. The method of claim 1, wherein the predicted value for each user in the group of users comprises a predicted level of engagement with the client application.

6. The method of claim 1, wherein the identification comprises the predicted value and a respective client device identifier.

7. The method of claim 1, wherein the new user finder is configured to identify prospective new users for the client application based on the provided identification of the subset of users.

8. The method of claim 7, wherein the new user finder is further configured to provide the prospective new users with offers to install the client application.

9. The method of claim 1, further comprising:
adjusting the predetermined threshold to achieve a desired frequency at which the identifications are provided to the new user finder.

10. The method of claim 1, further comprising:
identifying a second subset of users in the group of users for whom the predicted value does not exceed the predetermined threshold; and
providing an identification to the new user finder of one or more users in the second subset of users based on random number generation.

11. A system, comprising:
one or more computer processors programmed to perform operations comprising:
providing a client application to a group of users;
obtaining data related to interactions between the client application and each user in the group of users;
providing the data to a predictive model configured to receive the data as input and provide as output a predicted value of each user in the group of users, the predicted value comprising a predicted measure of how valuable the user will be to the client application;
identifying a subset of users in the group of users for whom the predicted value exceeds a predetermined threshold;
for each user in the subset of users, providing an identification of the user to a new user finder; and
providing the client application to a new group of users,
wherein the new group of users was acquired through the new user finder based on the provided identification of the subset of users.

12. The system of claim 11, wherein the client application comprises an online game.

13. The system of claim 11, wherein the predicted value for each user in the group of users comprises a predicted likelihood that the user will be a payer in the client application.

14. The system of claim 11, wherein the predicted value for each user in the group of users comprises a predicted level of engagement with the client application.

15. The system of claim 11, wherein the identification comprises the predicted value and a respective client device identifier.

16. The system of claim 11, wherein the new user finder is configured to identify prospective new users for the client application based on the provided identification of the subset of users.

17. The system of claim 16, wherein the new user finder is further configured to provide the prospective new users with offers to install the client application.

18. The system of claim 11, wherein the operations further comprise:
adjusting the predetermined threshold to achieve a desired frequency at which the identifications are provided to the new user finder.

19. The system of claim 11, wherein the operations further comprise:
identifying a second subset of users in the group of users for whom the predicted value does not exceed the predetermined threshold; and
providing an identification to the new user finder of one or more users in the second subset of users based on random number generation.

20. An article, comprising:
a non-transitory computer-readable medium having instructions stored thereon that, when executed by one or more computer processors, cause the one or more computer processors to perform operations comprising:
providing a client application to a group of users;
obtaining data related to interactions between the client application and each user in the group of users;
providing the data to a predictive model configured to receive the data as input and provide as output a predicted value of each user in the group of users, the predicted value comprising a predicted measure of how valuable the user will be to the client application;
identifying a subset of users in the group of users for whom the predicted value exceeds a predetermined threshold;
for each user in the subset of users, providing an identification of the user to a new user finder; and
providing the client application to a new group of users,
wherein the new group of users was acquired through the new user finder based on the provided identification of the subset of users.
